(19) United States
(12) Patent Application Publication
(10) Pub. No.: US 2013/0267108 A1
(43) Pub. Date: Oct. 10, 2013

(54) CARD UNIT AND CARD EDGE CONNECTOR

(71) Applicant: J.S.T. MFG. CO., LTD., Osaka (JP)

(72) Inventor: Akira NAGAMINE, Miyoshi-shi (JP)

(73) Assignee: J.S.T. Mfg. Co., Ltd., Osaka (JP)

(21) Appl. No.: 13/856,040

(22) Filed: Apr. 3, 2013

(30) Foreign Application Priority Data
Apr. 4, 2012 (JP) 2012-085297

(51) Int. Cl. H01R 13/52

(52) U.S. Cl. CPC H01R 13/52
USPC 439/271

(57) ABSTRACT

A card unit comprises a substrate having a card edge section in which a plurality of card edge terminals connected to an opposing connector are formed on at least one surface, and a case formed as a bottomed box shape having an accommodating section in which the substrate is accommodated and an open section provided at one end; wherein a retainer is mounted to the case so as to close up the open section, the retainer is formed as a box shape having an opening at one end and a closed section disposed inside the case at the other end, and having a core section formed shorter than the length of the case; a groove section into which the card edge section protrudes is formed in the closed section; and the card edge section is covered by the core section of the retainer.

### TECHNICAL FIELD

The present invention relates to a card unit and a card edge connector in which a substrate having a card edge terminal formed thereon for connecting with an opposing connector is accommodated in a case. Specifically, the present invention relates to a card unit and a card edge connector having drip-proof and dust-proof functions with respect to the substrate, and having a structure whereby physical impact against the card edge terminal can be minimized.

### BACKGROUND

When a substrate on which an electronic circuit or the like is formed is connected to an electronic device, or the like, there are cases in which the substrate and a connector must be connected directly. Card edge substrates, card edge connectors, and the like having terminals formed in the end of a substrate are known as means for directly connecting a substrate and a connector. Solutions have been devised for resolving the various inconveniences that could arise when the card edge terminals are connected to an opposing connector in such a card edge substrate or the like.

For example, Japanese Laid-open Patent Application No. 2011-210457 discloses an invention of an electronic circuit unit capable of external connections. The electronic circuit unit disclosed in Japanese Laid-open Patent Application No. 2011-210457 comprises a circuit substrate having an edge section provided with a plurality of connecting conductors on the surface, a case for accommodating the circuit substrate, and a connector for connecting electric wires to the connecting conductors of the circuit substrate, wherein the case has an open section which opens in a specified direction and a shape whereby the circuit substrate can be held in a specified substrate holding position inside the case, the connector comprises a plurality of terminals capable of conduction with the connecting conductors and a housing for holding the terminals, and the connector has a lid for closing up the open section of the case in a position such that the terminals held in the housing are in contact with the respective connecting conductors of the circuit substrate in the substrate holding position.

With such a configuration, according to the electronic circuit unit disclosed in Japanese Laid-open Patent Application No. 2011-210457, there is no need to use both a terminal-side housing and a substrate-side housing as in conventional practice, and contact between the terminals of the connector and the connecting conductors of the circuit substrate is guaranteed by a simple structure that uses a case. Specifically, due to the housing interlocking with the case and the lid of the housing closing up the open section of the case while the circuit substrate is held in the substrate holding position in the case, contact between the terminals of the connector and the connecting conductors in the circuit substrate is maintained without the use of multiple housings.

The card edge substrate and the card member are used in various conditions. For example, when the substrate and the connector are connected in locations such as those exposed to rainwater outdoors or those where dust is abundant, there is a risk of water or dirt infiltrating the substrate in the case and affecting the operation of the circuitry. When an operator touches the substrate or the card edge terminals, there is also a risk of the circuitry or the like being contaminated. Particularly in cases in which the card member is incorporated in an automobile or another vehicle, there is a risk of the operator contaminating the substrate by performing the work of attaching the substrate with dirty hands after performing other work, such as touching the oil, for example.

Therefore, in the electronic circuit unit disclosed in Japanese Laid-open Patent Application No. 2011-210457, when the connecting conductors of the circuit substrate accommodated in the case and the terminals of the connector are connected, the open section of the case is closed up by the lid of the housing of the connector. However, while the connecting conductors of the circuit substrate accommodated in the case and the terminals of the connector are not connected, the open section of the case is constantly open. Therefore, there is a risk of liquid, dust, and the like getting on the substrate in the case through the open section.

### SUMMARY

The present invention was devised in order to solve such problems inherent in conventional techniques, it being an object of the present invention to provide a card unit wherein the infiltration of liquid, dust, or the like into the case can be suppressed even before a connection to the connector is made and physical impact to the card edge section can be suppressed, by accommodating a card member having card edge terminals on a substrate inside a case and using a retainer for restraining the substrate from moving to close up the open section of the case.

Another object of the present invention is to provide a card edge connector wherein liquid or dust entering the case can be suppressed by connecting the card unit described above with an opposing connector.

To solve the problems described above, an aspect of the card unit of the present invention is: a card unit comprising a substrate having a card edge section in which a plurality of card edge terminals connected to an opposing connector are formed on at least one surface; and a case having an accommodating section in which the substrate is accommodated, the case being and formed as a bottomed box shape provided with an open section at one end; wherein a retainer is mounted to the case so as to close up the open section; the retainer is formed as a box shape having an opening at one end and a closed section disposed inside the case at the other end, and having a core section formed shorter than the length of the case; a groove section into which the card edge section protrudes is formed in the closed section; and the card edge section is covered by the core section of the retainer.

In an aspect of the card unit of the present invention, a guide section for guiding and positioning the substrate is formed on an inner side of the case.

In an aspect of the card unit of the present invention, at least one partition is provided in the groove section of the retainer.

In an aspect of the card edge connector of the present invention, a card edge connector comprises: a card unit; and an opposing connector connected with the card unit; wherein the card unit including: a substrate having a card edge section being provided with a plurality of card edge terminals to be connected to an opposing connector on at least one surface of the card edge section; and a case having an accommodating section in which the substrate is accommodated, the case being formed as a bottomed box shape provided with an open section at one end; wherein a retainer is mounted to the case so as to close up the open section; the retainer is formed as a box shape having an opening at one end and a closed section disposed inside the case at the other end, and having a core section formed shorter than the length of the case; a groove section into which the card edge section protrudes is formed in the closed section; and the card edge section is covered by the core section of the retainer.

In an aspect of the card edge connector of the present invention, the opposing connector has a cover connected to the card unit;

at least one watertight lip formed into an annular shape is provided to an outer portion of the case connected to the cover; and
when the case and the cover are connected, the outer side of the case and the cover are sealed together.

According to an aspect of the card unit of the present invention, because the open section of the case in which the substrate is accommodated is closed by the retainer, infiltration of liquid or dust into the case can be suppressed. Because the card edge section of the substrate protruding into the groove section formed in the retainer is covered not only by the case but also by the core section of the retainer formed as a box shape, external impact to the card edge terminals during operations can be suppressed. Furthermore, because the substrate accommodated in the case is fixed by the retainer, movement or separation of the substrate during attachment or other operations can be suppressed, handling is easier, and the efficiency of operations such as attaching can be increased. Because the substrate can be distributed as a unit, there is no need to assemble the substrate at the site of operations, and operating efficiency can be further increased. Furthermore, because the substrate in the case can be easily replaced, maintenance and version upgrades of the substrate can be performed easily.

According to an aspect of the card unit of the present invention, the substrate is easily accommodated inside the case, and the substrate can be reliably fixed in place.

According to an aspect of the card unit of the present invention, movement of the substrate is better suppressed and the substrate can be reliably fixed in place by fitting the partition formed in the groove section of the retainer with a concavity formed in the substrate.

According to an aspect of the card edge connector of the present invention, it is possible to obtain a card edge connector which exhibits the effects of the card unit of any of the first through third aspects.

According to an aspect of the card edge connector of the present invention, a higher watertight and dust-tight card edge connector can be obtained by sealing and connecting the cover of the opposing connector and the case of the card unit.

### BRIEF DESCRIPTION OF THE DRAWINGS

FIG. 1 is a perspective view of the card edge connector of the embodiment;

FIG. 2 is an exploded perspective view of the card edge connector of the embodiment;

FIG. 3 is an exploded perspective view of the card unit of the embodiment; and

FIG. 4 is an exploded perspective view of the opposing connector of the embodiment.

### DETAILED DESCRIPTION

An embodiment of the present invention is described below with reference to the drawings. The embodiment presented below gives an example of a card unit and a card edge connector for specifying the technical ideals of the present invention, but the present invention is not meant to be specified as such and can be equally adapted to other embodiments included within the scope of the claims.

### Embodiment

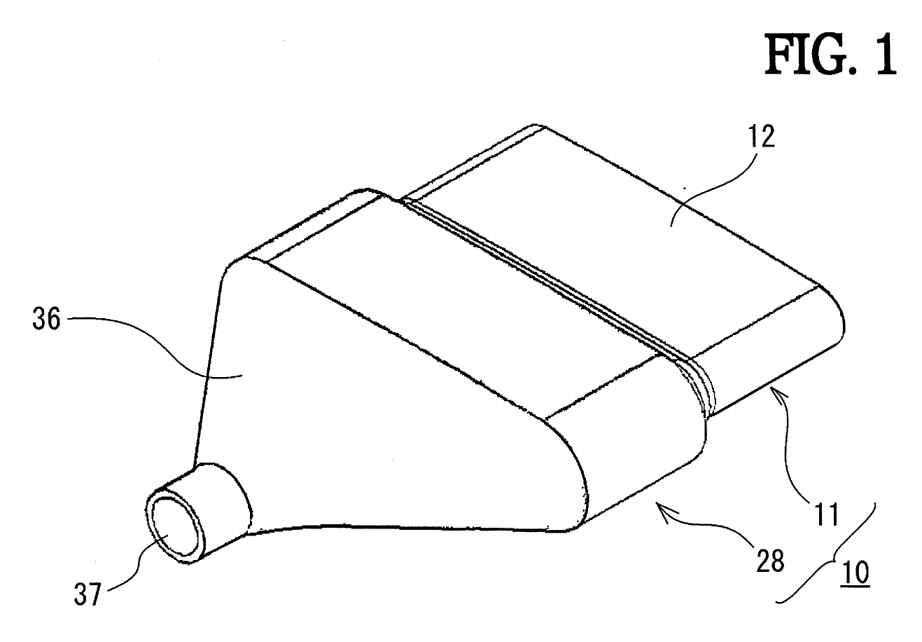

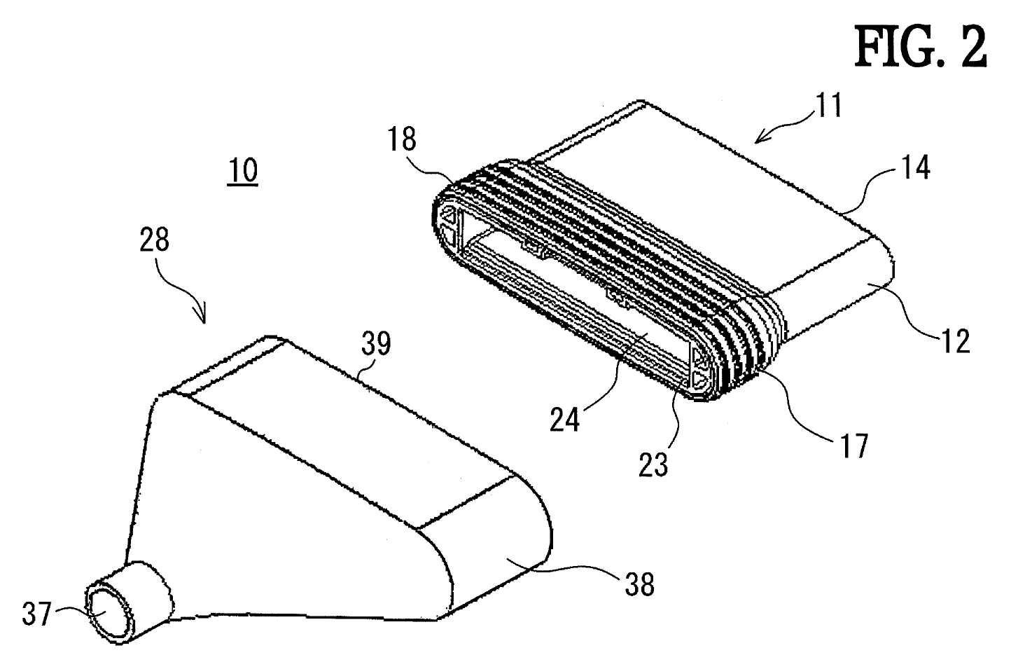

A card edge connector 10 of the embodiment is described with reference to FIGS. 1 to 4. The card edge connector 10 is configured from a card unit 11 and an opposing connector 28 to which the card unit 11 is connected, as shown in FIGS. 1 and 2.

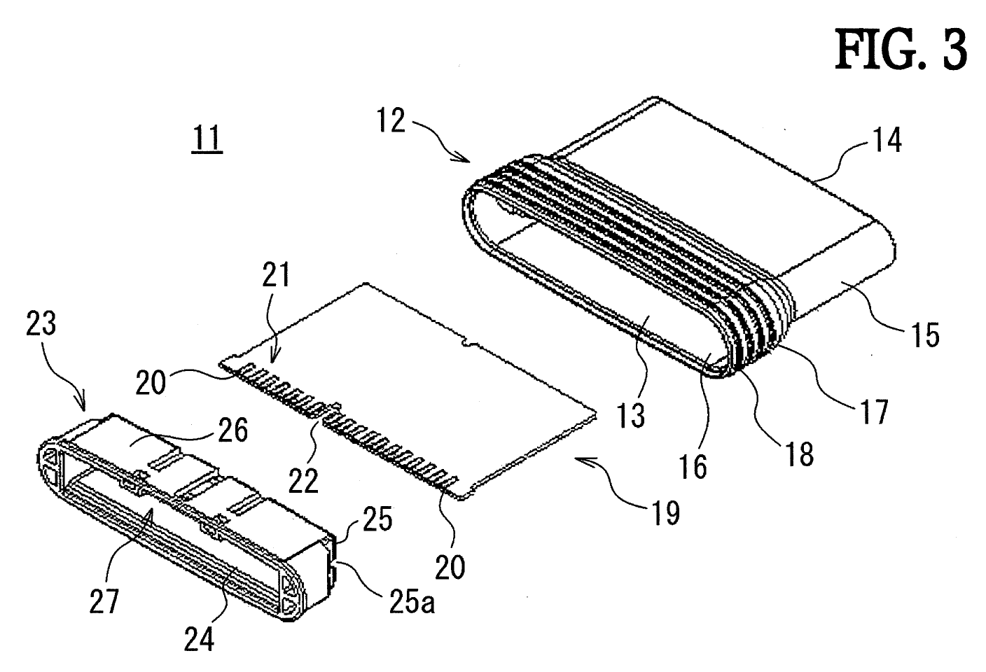

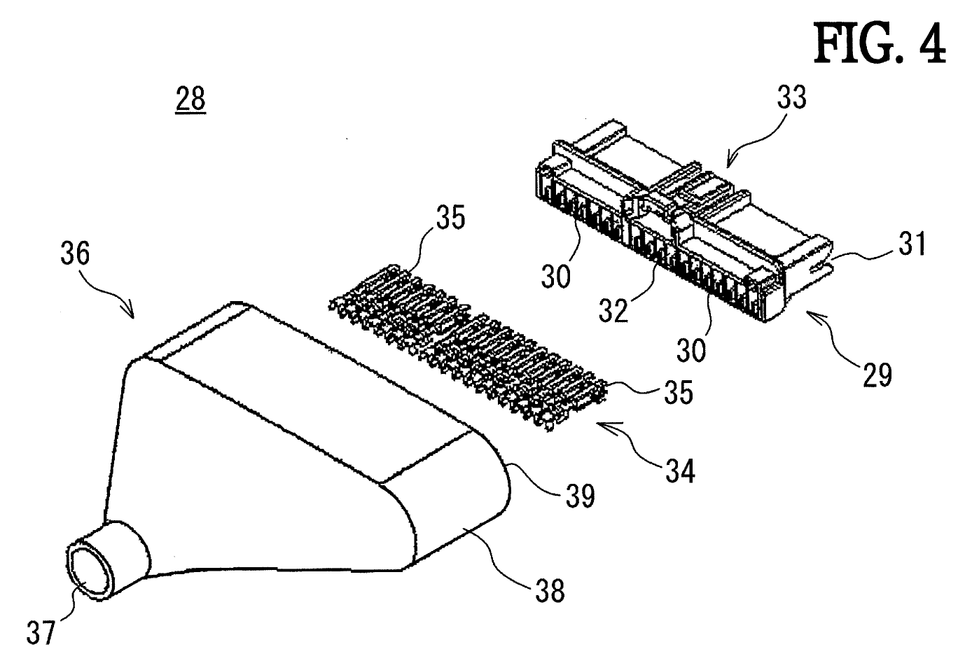

First, the card unit 11 of Embodiment 1 is described with reference to FIGS. 2 and 3. The card unit 11 is configured from: a substrate 19 having a card edge section 21 on which a plurality of card edge terminals 20 are formed, the card edge terminals being connected to a contact 34 (see FIG. 4) having a printed circuit and various electronic components or integrated circuits and the like disposed thereon and provided at one end to the opposing connector 28; an open section 13 which is the portion where the substrate 19 is inserted and withdrawn; a case 12 formed as a bottomed box shape having an accommodating section 15 inside of which the substrate 19 is accommodated; and a retainer 23 mounted so as to seal up the open section 13 of the case 12 and having a groove 25a formed into which the card edge section 21 protrudes, as shown in FIG. 3. These components are described in detail below.

The substrate 19 has a printed circuit and various electronic components or integrated circuits or the like disposed on the front surface or rear surface, and at the end of the substrate is the card edge section 21 on which the plurality of card edge terminals 20 are formed, which are brought in contact and electrically connected to the contact 34 of the opposing connector 28, as shown in FIG. 3. The card edge terminals 20 are formed from an electroconductive material which conducts with the circuit wires and the like formed on the substrate 19, and are placed at predetermined intervals. At least one concavity 22 is formed in the card edge section 21, and the concavities fit together with partitions formed in the retainer 23, described hereinafter. The substrate 19 may have wires formed on both sides, and a multilayer stacked substrate may be used in which a plurality of substrates are stacked for forming one unit.

The case 12 is formed as a bottomed box shape having the open section 13 which is open at one end, and a bottom section 14 at the other end, as shown in FIGS. 2 and 3. The shape of the case 12 is that of a flat tube in the embodiment, but is not limited; a cuboid shape may also be adopted. The accommodating section 15 for accommodating the substrate 19 is formed in the bottom section 14 side of the case 12, and a retainer mounting section 16 for mounting the retainer 23 is formed on the inner side of the case 12, on the open section 13 side of the case 12.

The retainer mounting section 16 is formed having a larger outside diameter than the accommodating section 15. The outer side of the retainer mounting section 16 is a connector mounting section 17 mounted with the opposing connector 28, and at least one watertight lip 18 is formed as an annular protrusion. Also formed on the inner side of the accommodating section 15 is a guide section (not shown) whereby the substrate 19 is guided and positioned when the substrate 19 is accommodated therein.

The retainer 23 is next described with reference to FIGS. 2 and 3. The retainer 23 is formed as a box shape having an opening 24 at one end and a closed section 25 at the other end, and the retainer 23 is mounted to the retainer mounting section 16 of the case 12 from the closed section 25 side. In order for the retainer 23 to be mounted in the retainer mounting section 16 formed on the inner side of the open section 13 of the case 12, the retainer 23 has a core section 26 formed shorter than the axial length of the case 12, and the core section 26 is formed so as to be capable of being fitted into the retainer mounting section 16. The shape of the retainer 23 is formed so as to correspond with the open section 13 of the case 12, and in the embodiment this shape is formed as a flat tube. This allows the open section 13 of the case 12 to be sealed by the retainer 23.

The opening 24 of the retainer 23 is a portion connected to a housing 29 to which the contact 34 of the opposing connector 28 is mounted, and formed on the inner side of the opening 24 is a first interlocking section 27 which interlocks with the housing 29 of the opposing connector 28.

The groove 25a is formed such that the card edge section 21 formed in the substrate 19 protrudes into the closed section 25 of the retainer 23. The card edge terminals 20 of the card edge section 21 protruding from the groove 25a are designed to be connected to the contact 34 of the opposing connector 28 inside the retainer 23. At least one partition (not shown) is formed in the groove 25a, and the partitions and the concavities 22 formed in the substrate 19 fit together, whereby the substrate 19 is restrained from moving and can be positioned and fixed in place.

Next, assembling the card unit 11 is described. Assembling the card unit 11 involves first inserting the substrate 19 into the accommodating section 15 through the open section 13 of the case 12. At this time, by being inserted along the guide section (not shown) formed inside the accommodating section 15, the substrate 19 can easily be inserted and can also be easily positioned. Next, the retainer 23 is inserted from the closed section 25 side into the open section 13 of the case 12, the card edge section 21 of the substrate 19 is made to protrude from the groove 25a formed in the closed section 25 of the retainer 23, and the retainer 23 is mounted in the retainer mounting section 16 of the case 12.

This makes it possible to suppress infiltration of liquid and dust into the case of the card unit of the embodiment. The card edge section of the substrate is covered by the retainer and the retainer mounting section of the case, whereby external impact can be suppressed from acting on the card edge terminals during operation, and damage to the substrate and the card edge terminals or other adverse events can be suppressed. Due to the substrate being distributed as a unit combining the case and the retainer, there is no need for any on-site assembly or the like, and operating efficiency can be further increased. Furthermore, because the substrate in the case can be easily replaced, maintenance and version upgrades of the substrate can be performed easily.

The following is a description of connecting the card unit 11 and the opposing connector 28 constituting the card edge connector 10 of the embodiment, with reference made to FIGS. 1, 2, and 4. First, the opposing connector 28 of the embodiment is described with reference to FIG. 4. The opposing connector 28 is configured from the housing 29, a plurality of contacts 34 mounted in the housing 29, and a cover body 36 in which the housing 29 is accommodated.

The housing 29 is configured as a substantial cuboid, at one end of which is formed a contact insertion port 30 into which the plurality of contacts 34 are inserted, and at the other end of which a fitting groove 31, into which the card edge section 21 of the substrate 19 is fitted, is formed along the horizontal direction. The contact insertion port 30 at one end and the fitting groove 31 at the other end communicate through the inside of the housing 29, and a contact mounting section 32 in which the contacts 34 are mounted is formed in the contact insertion port 30 side inside the housing 29. Formed in the external peripheral surface of the housing 29 is a second interlocking section 33 which interlocks with the first interlocking section 27 formed in the retainer 23 of the card unit 11.

The plurality of contacts 34 are formed so that one end is connected to a wire harness (not shown), and the other end is mounted in the housing 29. In the end on the side mounted in the housing 29, a contact section 35 is formed which is connected to the card edge terminals 20 of the card unit 11.

The cover body 36 is formed in the shape of a tube, one end of which having a circular insertion port 37 through which the wire harness (not shown) connected to the contacts 34 is inserted, and the other end of which having a connection port 39 connected to the card unit 11. The connection port 39 side is provided with a housing accommodation section 38 for accommodating the housing 29 in which the contacts 34 are mounted, and from the connection port 39 and housing accommodation section 38 to the insertion port 37 is a portion which gradually narrows. Due to this narrowing of the cover body 36 up to the insertion port 37, the wire harness can be inserted all through a single location. The housing accommodation section 38 of the cover body 36 is formed slightly larger than the outer shape of the housing 29, and the connector mounting section 17 of the case 12 of the card unit 11 is mounted in the gap between the housing 29 and the housing accommodation section 38.

Next, the connecting of the card unit 11 and the opposing connector 28 is described. Connecting the card unit 11 and the opposing connector 28 involves first preparing the separately assembled card unit 11 and opposing connector 28 as shown in FIG. 2, and inserting the card unit 11 into the connection port 39 of the opposing connector 28 from the connector mounting section 17 side. At this time, the card unit is inserted so that the card edge section 21 of the card unit 11 is aligned with the fitting groove 31 of the housing 29 of the opposing connector 28, the opening 24 of the retainer 23 of the card unit 11 is aligned with the housing 29 of the opposing connector 28, and the connector mounting section 17 of the card unit 11 is aligned with the gap between the housing accommodation section 38 and the housing 29 of the opposing connector 28.

When the card unit 11 is inserted into the opposing connector 28, the card edge terminals 20 of the card edge section 21 are connected to the contact section 35 of the contacts 34 mounted in the housing 29, the first interlocking section 27 of the retainer 23 and the second interlocking section 33 of the housing 29 interlock, and the watertight lips 18 of the contact mounting section 32 are mounted forming a seal to the inner sides of the housing accommodation section 38 of the cover body 36. From the above process, the connection between the card unit 11 and the opposing connector 28 is finished, and the card edge connector 10 of the embodiment as shown in FIG. 1 is completed.

This makes it possible to suppress the infiltration of liquid, dust, and other foreign substances in the card unit 11, and the further increase the watertight and dust-tight properties of the card edge connector 10.

1. A card unit comprising:
a substrate having a card edge section being provided with a plurality of card edge terminals to be connected to an opposing connector on at least one surface of the card edge section; and
a case having an accommodating section in which the substrate is accommodated, the case being formed as a bottomed box shape provided with an open section at one end; wherein
a retainer is mounted to the case so as to close up the open section;
the retainer is formed as a box shape having an opening at one end and a closed section disposed inside the case at the other end, and having a core section formed shorter than the length of the case;
a groove section into which the card edge section protrudes is formed in the closed section; and
the card edge section is covered by the core section of the retainer.

2. The card unit according to claim 1, wherein a guide section for guiding and positioning the substrate is formed on an inner side of the case.

3. The card unit according to claim 1, wherein at least one partition is provided in the groove section of the retainer.

4. A card edge connector comprising:
a card unit; and
an opposing connector connected with the card unit; wherein the card unit including:
a substrate having a card edge section being provided with a plurality of card edge terminals to be connected to an opposing connector on at least one surface of the card edge section; and
a case having an accommodating section in which the substrate is accommodated, the case being formed as a bottomed box shape provided with an open section at one end; wherein
a retainer is mounted to the case so as to close up the open section;
the retainer is formed as a box shape having an opening at one end and a closed section disposed inside the case at the other end, and having a core section formed shorter than the length of the case;
a groove section into which the card edge section protrudes is formed in the closed section; and
the card edge section is covered by the core section of the retainer.

5. The card edge connector according to claim 4, wherein the opposing connector has a cover connected to the card unit;
at least one watertight lip formed into an annular shape is provided to an outer portion of the case connected to the cover; and
when the case and the cover are connected, the outer side of the case and the cover are sealed together.
